(19) United States
(12) Patent Application Publication
(10) Pub. No.: US 2017/0173766 A1
(43) Pub. Date: Jun. 22, 2017

(54) POWER TOOL ADAPTER

(71) Applicant: Illinois Tool Works Inc., Glenview, IL (US)

(72) Inventors: Michael C. Dill, Elk Grove Village, IL (US); Victor Truong, Schaumburg, IL (US)

(21) Appl. No.: 15/366,498

(22) Filed: Dec. 1, 2016

Related U.S. Application Data
(60) Provisional application No. 62/268,779, filed on Dec. 17, 2015.

(51) Int. Cl. B25B 23/00; B25B 21/00; B23B 31/107

(52) U.S. Cl. CPC B25B 23/0035; B23B 31/1075; B25B 21/007; B23B 2231/04

(57) ABSTRACT

A power tool adapter for both standard drills and impact drivers includes a shank or drill coupler including a head, a neck or clip retainer integrally connected to the head, and an extender integrally connected to the clip retainer; a drill bit locker integrally connected to the drill coupler and specifically integrally connected to the extender, and a sleeve engager integrally connected to the drill bit locker. The power tool adapter is configured to simultaneously hold or engage a drill bit and a torque sleeve.

### PRIORITY CLAIM

This application claims priority to and the benefit of U.S. Provisional Patent Application 62/268,779, filed Dec. 17, 2015, the entire contents of which are incorporated herein by reference.

### BACKGROUND

Power tools are well known and have been widely used in the construction industry and other industries for many years. These power tools are often cordless and enable a user to drill a hole into a material or structure (such as a wall) or drive a fastener (such as a screw).

Typical power tools include standard drills. Standard drills have an adjustable jaw for holding drill bits and screw bits. A user inserts a bit into the jaw, then closes the jaw until the bit is locked into place. The user activates the drill, causing the adjustable jaw to rotate the bit at a substantially constant speed. Standard drills typically include an adjustable trigger or dial, which enables the user to control the drill's power or torque. When drilling into relatively soft material, such as wood or plaster, a user applies low power or torque to avoid damaging the material. For tougher materials, such as concrete, a user applies more power or torque.

Impact drivers are a relatively newer power tool technology. Impact drivers have a fixed jaw, often called a hex slot or a hexagonal slot, for holding impact bits. A user inserts an impact bit having a hexagonal end into the impact driver's hex slot. The impact bit's hexagonal end matches the impact driver's hex slot. Instead of spinning at a substantially constant rate like a standard drill, the impact driver delivers sudden bursts of rotation. At the same time, the impact driver strikes the impact bit's base, which drives the impact bit forward. This motion is somewhat similar to quickly twisting a screw driver, while tapping the screw driver's base with a hammer for extra force. As a result, impact drivers are typically capable of applying substantially more power or torque than a standard drill.

This extra power or torque is particularly useful, for example, when drilling into a relatively tough material such as concrete. For some concrete walls, even a standard drill's highest power or torque setting is often inadequate to break through the concrete. An impact driver is often necessary in such cases.

This extra power is also useful, for example, when driving a fastener into concrete. If a power tool cannot generate enough power or torque to drive the fastener through the concrete, the tool might cause the fastener's head to rotate with respect to the fastener's body. This motion strips the fastener's head by deforming its grooves. For example, a fastener's head often defines two perpendicular grooves in an “X” or “t” shape. This is often called a “Phillips Head”. Stripping could blend those grooves together, causing the fastener's grooves to deform into an “O” shape. As a result, the fastener could become difficult or substantially impossible to drive.

In practice, workers in the construction industry often use impact drivers to mount objects onto concrete walls. First, a user drills a hole into the concrete wall with an impact drill bit. Next, the user replaces the impact drill bit with an impact screw bit. The user fits the impact screw bit's free end into a fastener's grooves. The user can now drive the fastener through an object and into the hole. The fastener mounts the object by squeezing it between the fastener's head and the concrete wall.

Since impact drivers typically have a fixed hex slot, they are only compatible with bits having a matching hex base. These special bits are often called impact bits. Impact bits may cause problems for users. Since impact drivers are a relatively newer technology, users may need to purchase new impact bits. Furthermore, users must spend time swapping out their impact drill bits for impact screw bits when a hole is ready to receive a fastener.

In a first specific example scenario, a user may take the following steps. First, the user mounts an impact drill bit into the impact driver. The user then drills a hole into a concrete wall. After drilling the hole, the user ejects the impact drill bit from the impact driver. The user then stores the impact drill bit. After doing so, the user finds an impact screw bit. The user mounts the impact screw bit into the impact driver. The user selects an object to mount and lines up the object's fastener hole with the fresh drill hole. The user fits a fastener through the object's fastener hole, into the fresh drill hole. The user then drives the fastener with the impact driver's impact screw bit. Various large objects may require multiple fasteners. If this is the case, the user must then eject the impact screw bit and store the impact screw bit. Afterwards, the user must find the original impact drill bit to restart the entire process.

In a second specific example scenario, the user may drive with a standard drill instead of an impact driver. In particular, the user takes the following steps. First, the user mounts a drill bit into the standard drill. The user then drills a hole into a plaster wall. After drilling the hole, the user ejects the drill bit from the standard drill. The user then stores the drill bit. After doing so, the user finds a screw bit. The user mounts the screw bit into the standard drill. The user selects an object to mount and lines up the object's fastener hole with the fresh drill hole. The user fits a fastener through the object's fastener hole, into the fresh drill hole. The user then drives the fastener with the standard drill's screw bit. Various large objects may require multiple fasteners. If this is the case, the user must then eject the screw bit and store the screw bit. Afterwards, the user must find the original drill bit to restart the entire process.

In a third specific example scenario, the user drills with one power tool, such as a standard drill, and drives the fastener with another power tool, such as an impact driver. Here, the user saves some time by eliminating the ejecting, mounting, storing, and finding steps. In this third specific example scenario, however, the user requires two power tools and two power sources for the power tools, adding expense. Additionally, in this example scenario, the user adds the steps of safely putting down and picking up the power tools. This may be especially inconvenient, for example, if the user is working on a ladder.

Accordingly, there is a need for a power tool adapter that solves these problems.

### SUMMARY

In various embodiments, the power tool adapter of the present disclosure solves the above problems by enabling a user to efficiently drill holes and drive fasteners without mounting or dismounting bits. The power tool adapter is configured to be used with one or more sleeves, one or more drill bits, and one or more impact screw bits. The power tool adapter of various embodiments of the present disclosure generally includes: (a) a shank or drill coupler including a head, a neck or clip retainer integrally connected to the head, and an extender integrally connected to the clip retainer; (b) a drill bit locker integrally connected to the drill coupler and specifically integrally connected to the extender; and (c) a sleeve engager integrally connected to the drill bit locker.

For an impact driver, the user inserts and secures the shank or drill coupler at one end of the power tool adapter in the impact driver and locks a drill bit in the drill bit locker of the power tool adapter. The user may now drill with the impact driver. When finished drilling the hole, the user fits a torque sleeve over the sleeve engager of the power tool adapter and secures the torque sleeve in place. The torque sleeve covers the drill bit. An impact screw bit can be pre-locked in the opposite end of the torque sleeve. The user may now drive a fastener by transmitting power and torque from the impact driver through the power tool adapter, the torque sleeve, and the impact screw bit to the fastener. When the user is finished driving the fastener, the user may simply remove the torque sleeve to expose the drill bit.

Thus, when using the power tool adapter of various embodiments of the present disclosure with an impact driver, the user no longer needs to: (a) eject an impact drill bit; (b) store the impact drill bit; (c) find an impact screw bit; (d) mount the impact screw bit; (e) eject the impact screw bit; (f) store the impact screw bit; (g) find the impact drill bit; and (h) mount the impact drill bit.

For a standard drill, the user inserts and secures the shank or drill coupler at one end of the power tool adapter in the standard drill and locks a drill bit in the drill bit locker of the power tool adapter. The user may now drill with the standard drill. When finished drilling the hole, the user fits a torque sleeve over the sleeve engager of the power tool adapter and secures the torque sleeve in place. The torque sleeve covers the drill bit. A screw bit can be pre-locked in the opposite end of the torque sleeve. The user may now drive a fastener by transmitting power and torque from the standard drill through the power tool adapter, the torque sleeve, and the screw bit to the fastener. When the user is finished driving the fastener, the user may simply remove the torque sleeve to expose the drill bit.

Thus, when using the power tool adapter of various embodiments of the present disclosure with a standard drill, the user no longer needs to: (a) eject a drill bit; (b) store the drill bit; (c) search for a screw bit; (d) mount the screw bit; (e) eject the screw bit; (f) store the screw bit; (g) find the drill bit; and (h) mount the drill bit.

It should be appreciated that the present disclosure includes the power tool adapter, the torque sleeve, and a combination of the power tool adapter and the torque sleeve.

Additional features and advantages of the present disclosure are described in, and will be apparent from the following Detailed Description and the Figures.

### BRIEF DESCRIPTION OF THE FIGURES

FIG. 1 is a top perspective view of one example embodiment of a power tool adapter of the present disclosure.

FIG. 2 is a top plan view of the power tool adapter of FIG. 1.

FIG. 3 is an enlarged cross sectional view the power tool adapter of FIG. 1, taken substantially along line 3-3 of FIG. 2 and showing a cross section of the head of the shank.

FIG. 4 is an enlarged cross sectional view of the power tool adapter of FIG. 1, taken substantially along line 4-4 of FIG. 2 and showing a cross section of the drill bit locker.

FIG. 5 is an enlarged cross sectional view of the power tool adapter of FIG. 1, taken substantially along line 5-5 of FIG. 2 and showing a cross section of a sleeve engager of the sleeve gripper.

FIG. 6 is a side plan view of an assembly of the power tool adapter of FIG. 1, an impact driver (shown in fragmentary), and a drill bit.

FIG. 7 is an exploded side plan view of an assembly of an impact driver (shown in fragmentary), the power tool adapter of FIG. 1, a drill bit locked in to the power tool adapter, a torque sleeve, an impact screw bit, and a fastener.

FIG. 8 is a side plan view of an assembly of an impact driver (shown in fragmentary), the power tool adapter of FIG. 1, a torque sleeve, an impact screw bit, and a fastener.

FIG. 9 is an enlarged cross sectional view of the torque sleeve of FIG. 8, taken substantially along line 9-9 of FIG. 8 and showing a cross section of the adapter engager of the torque sleeve.

FIG. 10 is an enlarged cross sectional view of the torque sleeve of FIG. 8, taken substantially along line 10-10 of FIG. 8 and showing a cross section of the bit engager of the torque sleeve.

FIG. 11 is a top perspective view of two different kinds of impact screw bits.

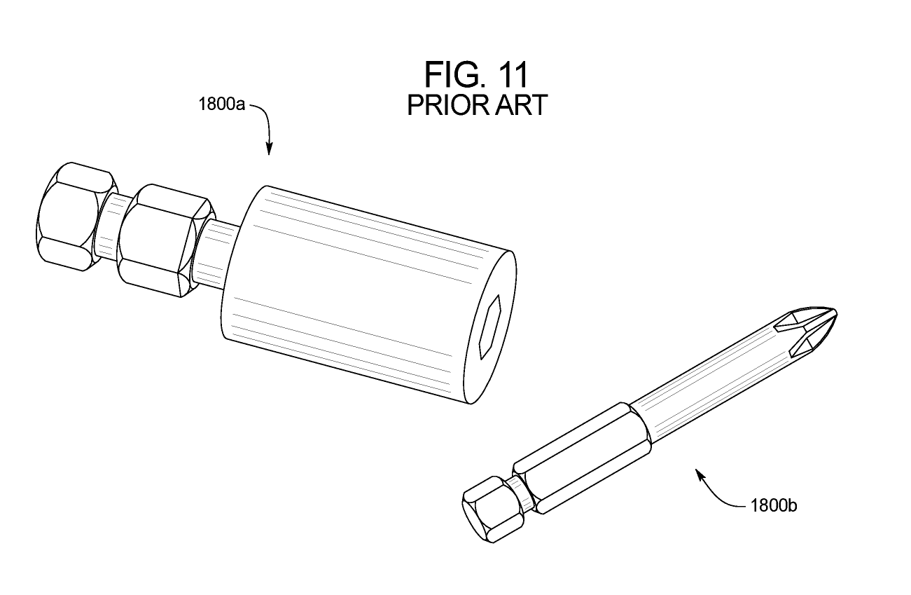

FIG. 12 is an enlarged cross sectional view of the torque sleeve of FIG. 8, taken substantially along line 12-12 of FIG. 8.

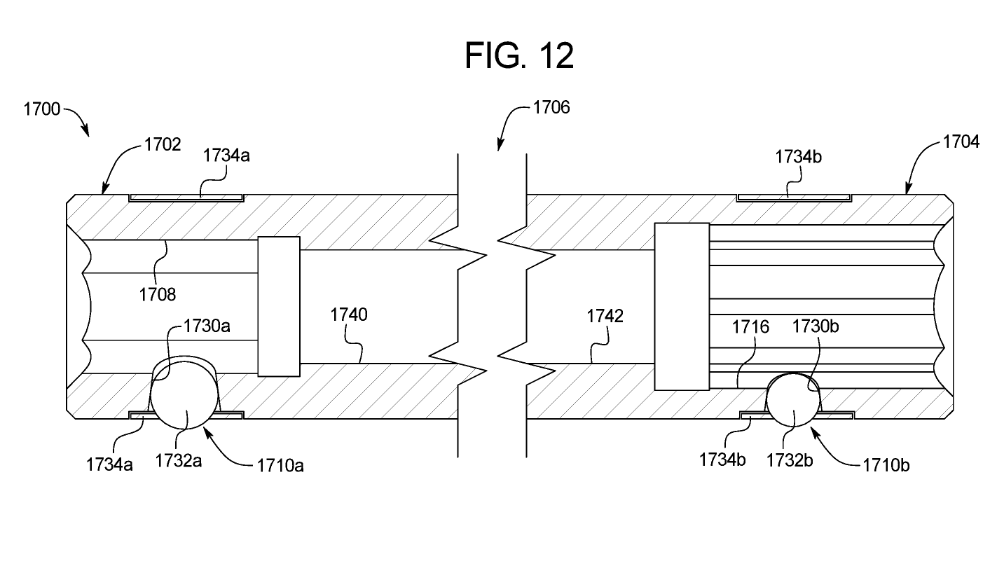

### DETAILED DESCRIPTION OF EXAMPLE EMBODIMENTS

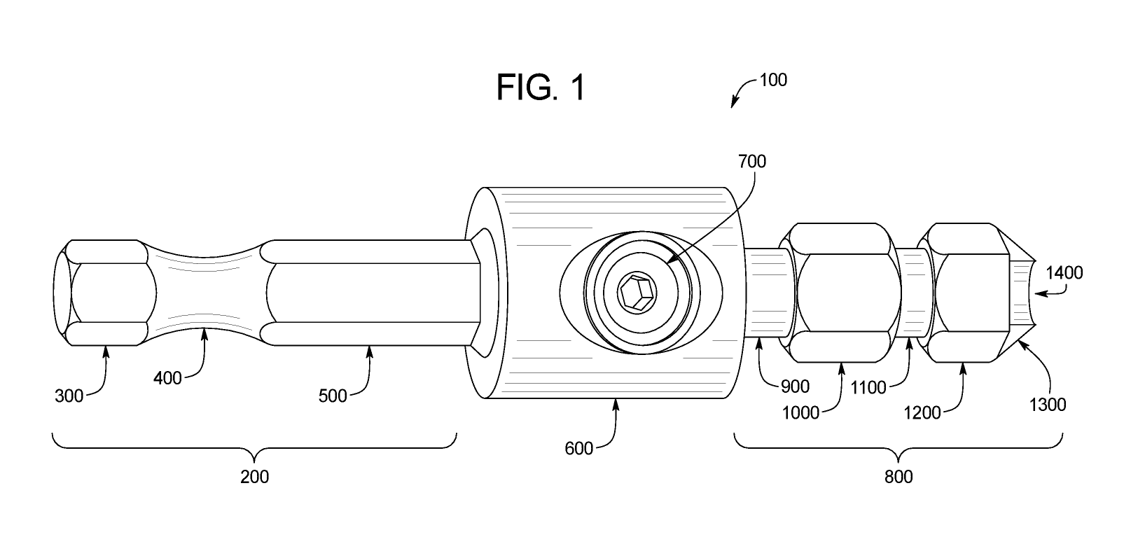

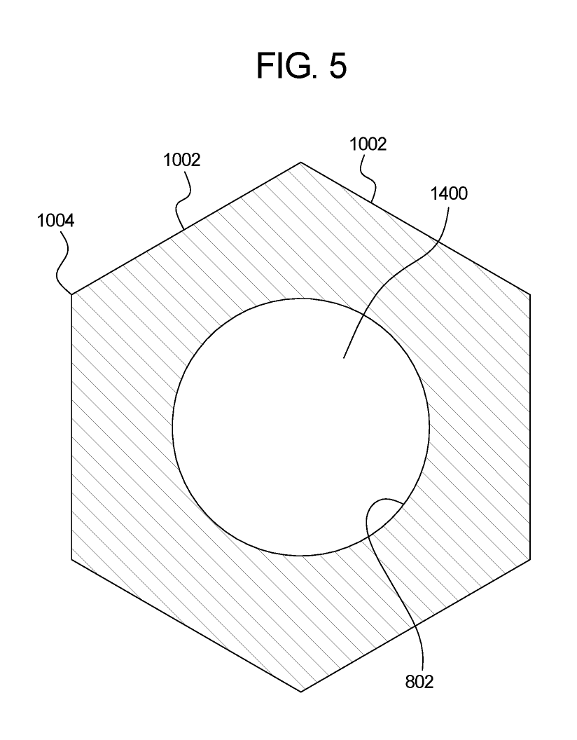

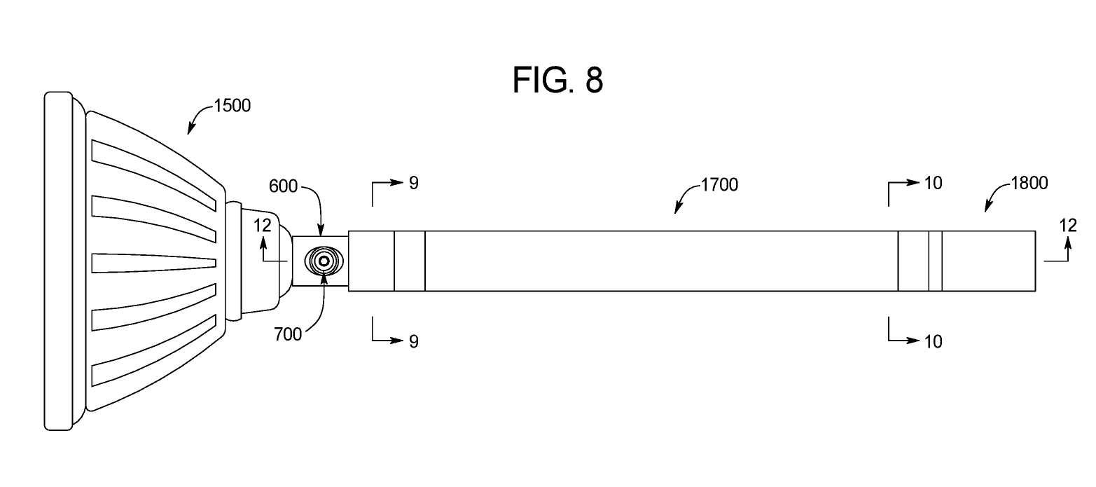

Referring now to the drawings, FIGS. 1 to 10 illustrate one example embodiment of the power tool adapter of the present disclosure, which is generally indicated by numeral 100. In this illustrated example embodiment, power tool adapter 100 generally includes: (a) a shank or drill coupler 200 including a head 300, a neck or clip retainer 400 integrally connected to the head 300, and an extender 500 integrally connected to the clip retainer 400; (b) a drill bit locker 600 integrally connected to the drill coupler 200 and specifically integrally connected to the extender 500; and (c) a sleeve gripper 800 integrally connected to the drill bit locker 600.

In this illustrated example embodiment, the shank or drill coupler 200 is configured to be inserted and secured in a longitudinal slot (not shown) of or defined by a power tool (such as an impact driver or standard drill).

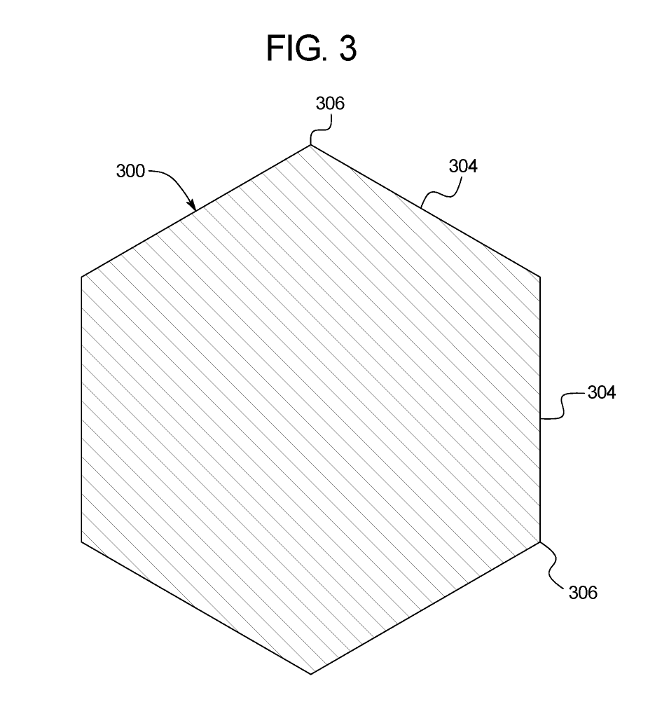

More specifically, the head 300 of the shank or drill coupler 200 is configured to be inserted into the longitudinal slot of a power tool. The head 300 includes a solid hexagonal head body having a flat circular end wall 302, six oval-shaped exterior surfaces 304 defining six exterior edges 306, and a circumferential cutting edge or end 308. The exterior surfaces 304 define a hexagonal perimeter of the solid head body of the head 300 as generally shown in the cross section of FIG. 3.

The clip retainer 400 of the shank or drill coupler 200 is also configured to be inserted into the longitudinal slot of a power tool. The clip retainer 400 includes a solid hour-glass shaped clip retainer body having a generally circular cross section. The solid clip retainer body includes a relatively narrow central portion 402 and two relatively wider end portions 404 and 408 extending from opposite ends of the central portion 402.

The extender 500 of the shank or drill coupler 200 is also configured to be inserted into the longitudinal slot of a power tool. The extender 500 partly includes a solid hexagonal extender body having a cutting edge 502 and six oval-shaped exterior surfaces 504 defining exterior edges 506. The extender also includes a somewhat cone-shaped transition 508 which is connected to the drill bit locker 600.

As mentioned above and as further discussed below, the head 300 of the power tool adapter can be secured in an impact driver or a standard drill.

More specifically, for the impact driver, the head 300 and the extender 500 of the shank or drill coupler 200 are configured to be secured in the longitudinal slot (which is often called a hex slot or hexagonal slot) of the impact driver. The hexagonal shapes of the head 300 and the extender 500 of the shank or drill coupler 200 are configured to prevent the power tool adapter 100 from rotating in the hexagonal slot of the impact driver. In other words, the hexagonal outer perimeters of the head 300 and the extender 500 match and engage the hexagonal inner perimeter of the hexagonal slot defined by the impact driver, and thus the head 300 and the extender 500 lack room in the hexagonal slot to spin or rotate.

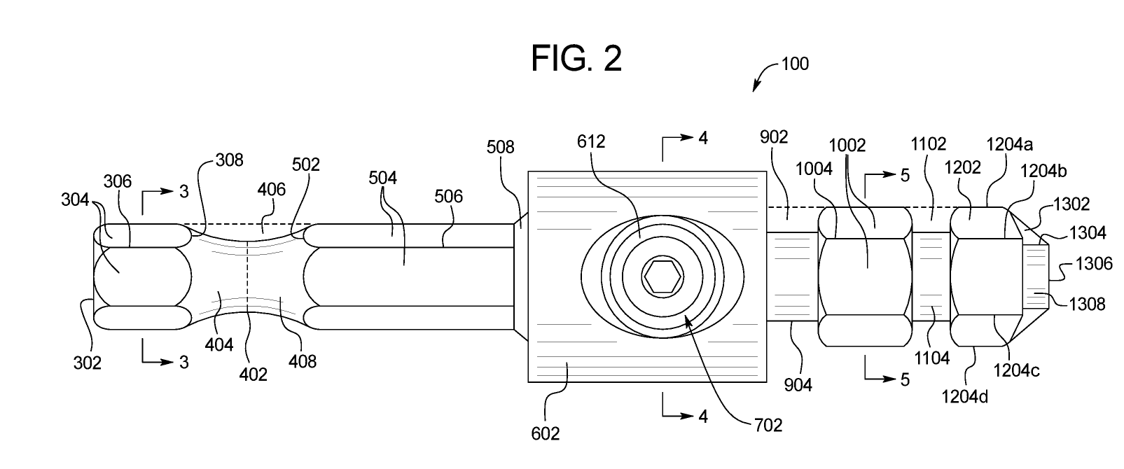

The shank or drill coupler 200 is also configured to prevent the power tool adapter 100 from unwanted longitudinal movement or sliding in or relative to the hexagonal slot of the impact driver. The neck or clip retainer 400 partially defines a semicircular gap 406 (indicated by a phantom line in FIG. 2) between the hour-glass shaped outer surface or perimeter of the neck or clip retainer 400 and an inner perimeter of the hexagonal slot of the impact driver. The semicircular gap 406 is configured to receive a retaining ball or clip of the impact driver. The retaining ball or clip is configured to slide in a channel radially and transversely extending from the hexagonal slot. When the neck or clip retainer 400 lines up with the channel, a spring of the impact driver pushes the retaining clip or ball partially into the semicircular gap 406. Since the spring holds the retaining clip or ball in the semicircular gap 406, the clip retainer 400 does not move longitudinally in the hexagonal slot during use of the impact driver. It should be appreciated that the clip retainer 400 is configured to enable the user to eject or expel the power tool adapter 100 from the hexagonal slot. More specifically, upon sufficient longitudinal force from a user, the clip retainer 400 pushes the retaining clip or ball back into the channel of the impact driver, thus enabling longitudinal movement of the power tool adapter 100 with respect to the hexagonal slot.

The shank or drill coupler 200 is configured to secure the power tool adapter 100 in the longitudinal slot (which is often called a jaw slot) of a standard drill. More specifically, a standard drill typically includes a jaw chuck (not shown) defining the jaw slot. The jaw chuck includes jaws radially extending toward or in the jaw slot. The head 300 and the extender 500 of the shank or drill coupler 200 are inserted into the jaw slot and the jaws are moved into engagement with the outer surfaces 504 of the extender 500. The jaws grip the exterior surfaces 504 of the extender 500. This gripping prevents the power tool adapter 100 from rotating and longitudinally moving or sliding in the jaw slot of the standard drill.

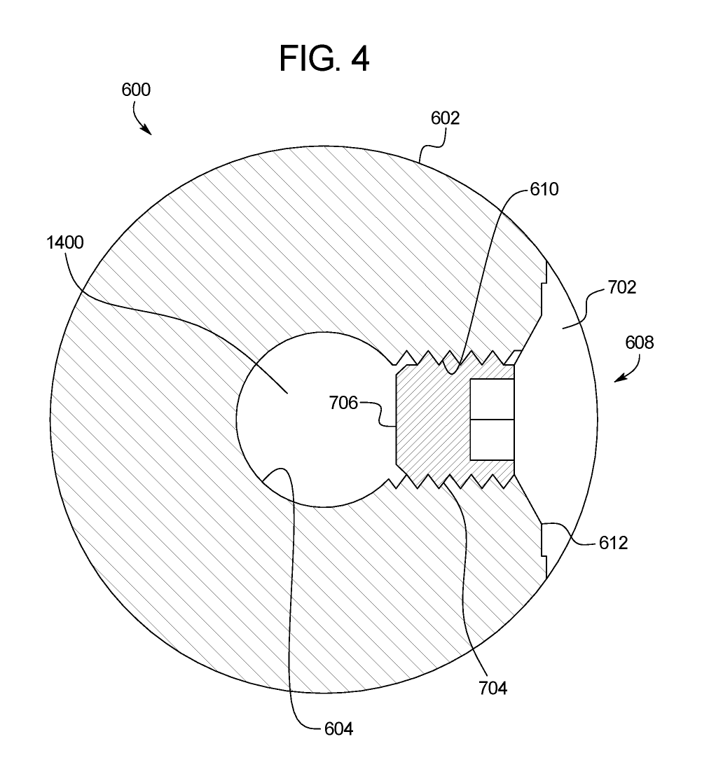

Referring now to FIGS. 1, 2, 4, 6, and 7, the drill bit locker 600 is configured to lock a drill bit 1600 in place in the power tool adapter 100. More specifically, the drill bit locker 600 includes a set screw 700 and a generally cylindrical hollow drill bit locker body. The drill bit locker body has a generally cylindrical exterior surface 602 and a generally cylindrical inner surface 604 defining a first portion of the drill bit receiving slot 1400. The drill bit locker body defines a transversely and radially extending set screw opening 608 having female threads 610. The set screw opening 608 transversely and radially extends from the drill bit receiving slot 1400 to the exterior surface 602 as best shown in FIG. 4. The drill bit locker body also has a shoulder 612, and an interior transversely extending stopping surface (not shown) defining an inner end of the drill bit receiving slot 1400.

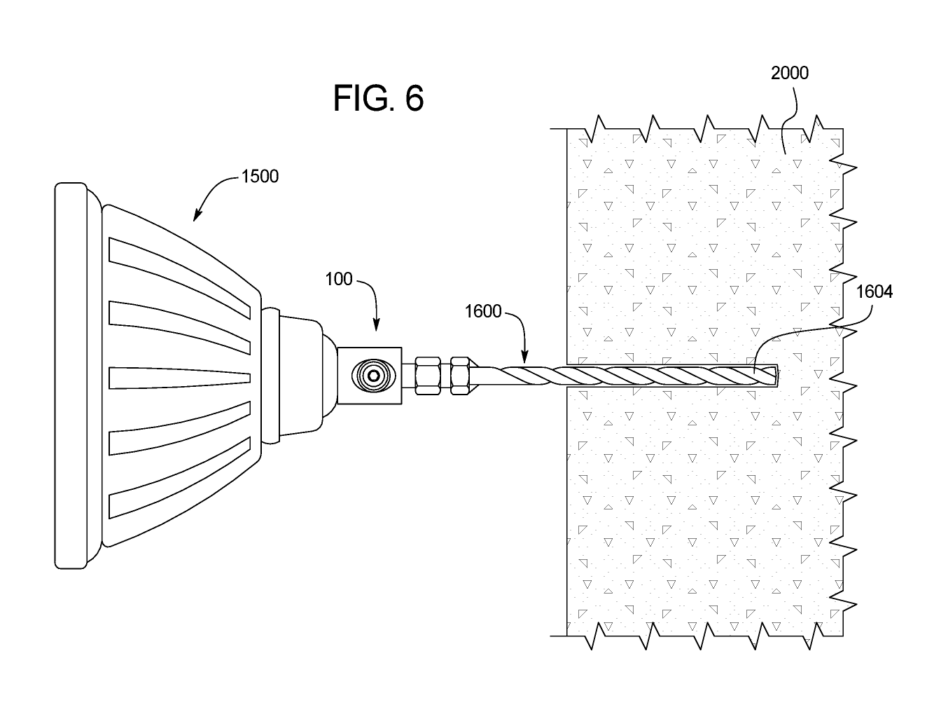

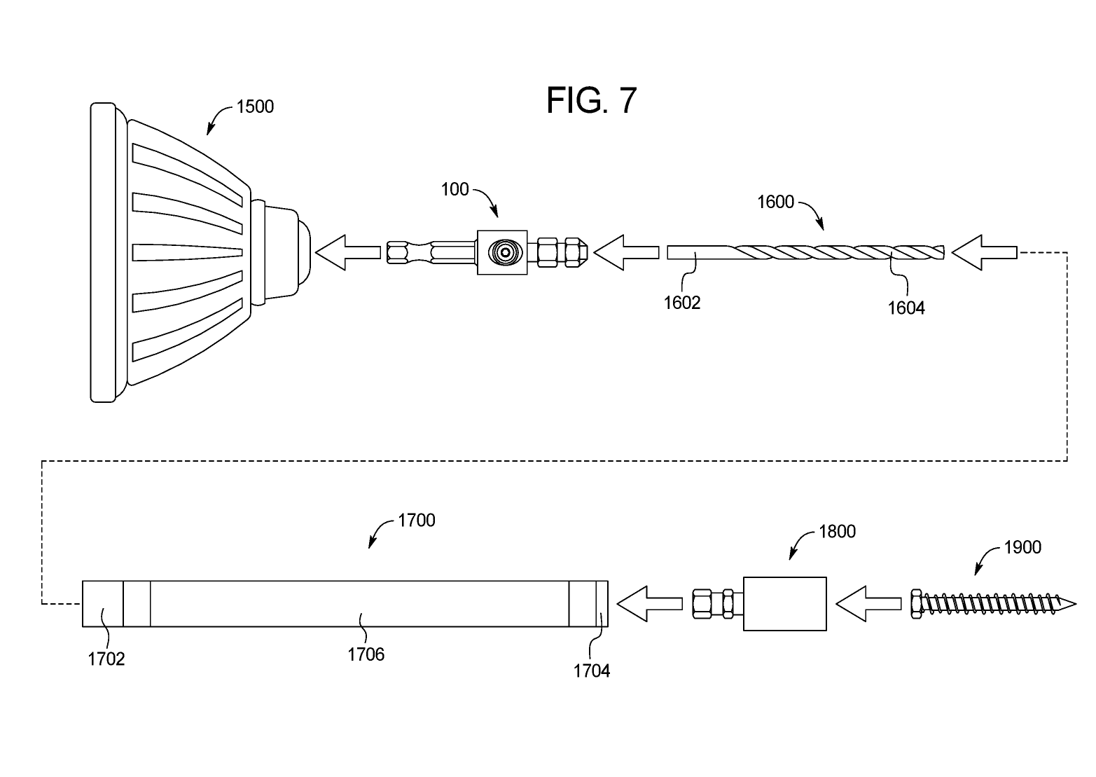

The drill bit receiving slot 1400 is configured to receive a locking end 1602 of the drill bit 1600, as shown in FIGS. 6 and 7. In use, as shown in FIG. 7, a user slides the drill bit 1600 into the drill bit receiving slot 1400 until the locking end 1602 of the drill bit 1600 contacts the stopping surface and lines up with the set screw opening 608. The user then screws the set screw 700 inwardly until the drill bit engagement surface 706 of the set screw 700 engages the locking end 1602 of the drill bit 1600.

The sleeve gripper 800 of the power tool adapter 100 is configured to simultaneously hold the drill bit 1600 and to engage an inner surface 1708 of the torque sleeve 1700. The torque sleeve 1700 is positionable over and around the sleeve gripper 800, as shown or indicated in FIGS. 6, 7, and 8. The illustrated sleeve gripper 800 generally includes: (a) a first cylindrical extender 900, (b) a first sleeve engager 1000, (c) a second cylindrical extender 1100, (d) a second sleeve engager 1200, and (e) a lip 1300.

More specifically, the first cylindrical extender 900 is sized to be positioned in or journaled in the torque sleeve 1700. The first cylindrical extender 900 includes a generally cylindrical and hollow first extender body having a cylindrical outer surface 904 and a cylindrical inner surface (not shown) which defines a second portion of the longitudinally extending drill bit receiving slot 1400. The first cylindrical extender 900 partially defines a first recess or slot 902 (indicated by a phantom line in FIG. 2).

The first sleeve engager 1000 is sized to be position in the positioned in or journaled in the torque sleeve 1700. The first sleeve engager 1000 includes a hexagonal and hollow first sleeve engager body defining a third portion of the longitudinally extending drill bit receiving slot 1400. The first sleeve engager body has six oval-shaped exterior surfaces 1002 defining exterior edges 1004. The first sleeve engager 1000 is configured to engage the inner surface 1708 of the torque sleeve 1700 to substantially prevent the torque sleeve 1700 from rotating relative to the sleeve gripper 800.

The second cylindrical extender 1100 is sized to be positioned in or journaled in the torque sleeve 1700. The second cylindrical extender 1100 includes a generally cylindrical and hollow second extender body having a cylindrical outer surface 1104 and a cylindrical inner surface (not shown) which defines a fourth portion of the longitudinally extending drill bit receiving slot 1400. The second cylindrical extender 1100 partially defines a second recess or slot 1102 (indicated by a phantom line in FIG. 2) configured to engage with a first retainer 1710a of the torque sleeve 1700. More specifically, the second recess or slot 1102 is defined between the outer surface or perimeter 1104 of the second extender body, the hexagonal inner surface 1708 of the torque sleeve, the first collar engager 1000, and the second collar engager 1200. When the first retainer 1710a lines up with the second recess or slot 1102, a spring or band of the torque sleeve 1700 pushes the retaining clip or ball partially into the second recess or slot 1102. The spring or band biases or holds the retaining ball or clip in the second recess or slot 1102, and prevents the torque sleeve from unwanted longitudinal movement along the power tool adapter.

The second sleeve engager 1200 is also sized to be positioned or journaled in the torque sleeve 1700. The second sleeve engager 1200 includes a hexagonal and hollow second engager body defining a fifth portion of the longitudinally extending drill bit receiving slot 1400. The second sleeve engager body has six exterior surfaces 1002 defining exterior edges 1004. Three of these exterior surfaces have straight end edges. The second sleeve engager 1200 is configured to engage the inner surface 1708 of the torque sleeve 1700 to substantially prevent the torque sleeve 1700 from rotating relative to the sleeve gripper 800. Thus, it should be appreciated that the first sleeve engager 1000 and the second sleeve engager 1200 co-act to prevent the torque sleeve 1700 from rotating relative to the power tool adapter 100.

The lip 1300 is also sized to be positioned in or journaled in the torque sleeve 1700. The lip 1300 has a semi-conical lip body including an exposed semi-cylindrical inner surface 1308, exposed triangular inner surfaces 1302 meeting the semi-cylindrical inner surface 1308 along edges 1304, a cone-shaped outer surface, and an edge 1306 joining the cone-shaped outer surface to the semi-cylindrical inner surface 1308. The exposed semi-cylindrical inner surface partially defines a sixth portion of the longitudinally extending drill bit receiving slot 1400. The exposed inner surface 1308 enables a user to easily align the drill bit 1600 in the drill bit receiving slot 1400. A small portion of three exterior surfaces 1202 of the second sleeve engager 1200 extend onto the cone-shaped outer surface of the lip 1300.

As shown in FIGS. 7, 8, and 9, the torque sleeve 1700 is configured to be positioned over or around the sleeve gripper 800. The torque sleeve 1700 is configured to simultaneously hold an impact screw bit 1800. The torque sleeve 1700 includes a hollow and elongated body having three sections or portions including: (a) an adapter engager 1702, (b) a middle section 1706, and (c) an impact bit engager 1704.

The adapter engager 1702 of the torque sleeve 1700 is configured to fit over and around the sleeve gripper 800. The adapter engager includes the generally hexagonal first inner surface 1708 and the first retainer 1710a.

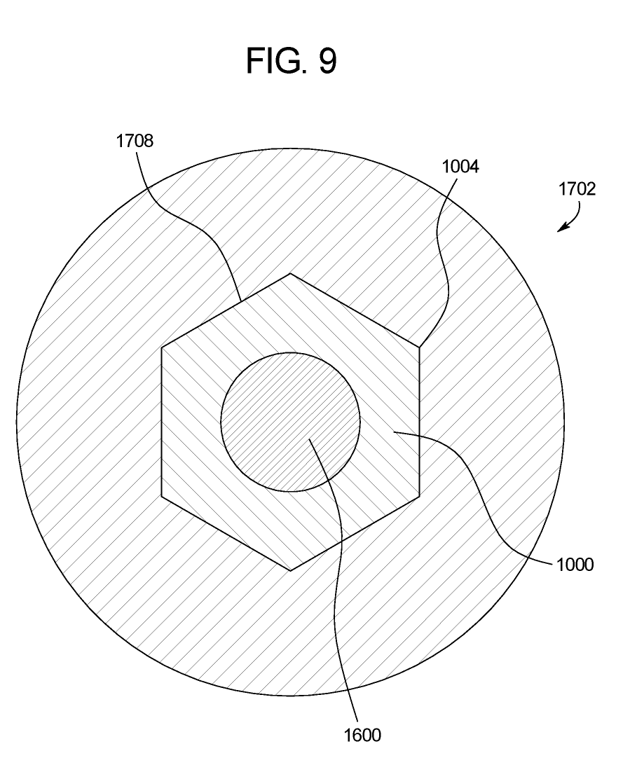

The generally hexagonal first inner surface 1708 is sized to be positioned over or journaled around the first and second sleeve engagers 1000 and 1200. FIG. 9 shows hexagonal first inner surface 1708 positioned around or joumaling the hexagonal body of the first sleeve engager 1000.

The first retainer 1710a is configured to engage the slot 1102. More specifically, the first retainer 1710a includes tapered inner surfaces 1730a defining a tapered channel, a retaining clip or ball 1732a positioned in the channel, and a circumferential band 1734a positioned in a circumferential groove defined around the outer surface of the sleeve engager 1700. The band 1734a biases the retaining clip or ball 1732a inwardly, toward the longitudinal centerline of the adapter engager 1702a. The tapered inner surfaces 1730a block the retaining clip or ball 1732a from passing through the full length of the channel and into the center of the torque sleeve 1700. As explained above, the retaining ball or clip 1732a prevents unwanted longitudinal movement or sliding of the torque sleeve 1700 along the sleeve gripper 800 of the power tool adapter 100. It should be appreciated sufficient force longitudinal force will push the retaining ball or clip 1732a outwardly in the channel 1730a, enabling a user to disconnect the sleeve 1700 from the sleeve gripper 800.

It should be appreciated that the above description also applies to the second retainer 1710b, which engages a slot defined between the impact drill bit 1800 and the torque sleeve 1700.

The middle portion 1706 is configured to cover the drill bit 1600 and to transmit torque from the adapter engager 1702 to the impact bit engager 1704. The middle portion 1706 has a hollow cylindrical body with generally cylindrical inner surfaces 1740 and 1744 defining a generally cylindrical longitudinal void.

The impact bit engager 1704 of the torque sleeve 1700 is configured to receive and hold an impact screw bit 1800. The impact bit engager 1704 has a hollow bit engager body with a generally hexagonal second inner surface 1716 and the second retainer 1710b.

The hexagonal inner surface 1716 is configured to be positioned over or journaled around a hexagonal head of an impact bit 1800.

As explained above, the second retainer 1710b is configured to secure the impact bit 1800 in place.

FIG. 6 shows a drill bit 1600 connected to a power tool 1500 via the power tool adapter 100 of the present disclosure. As described above, the drill bit 1600 is locked into the drill bit receiving slot 1400 via the drill bit locker 600. As shown in FIG. 7, the shank or drill coupler 200 is inserted into a longitudinal slot (not shown) of the power tool 1500. The power tool adapter 100 is secured to an impact driver power tool via the impact driver's hexagonal slot and retaining ball or clip. The power tool adapter 100 is secured to a standard drill power tool via the standard drill's jaw chuck. As shown in FIG. 6, the tip 1604 of the drill bit 1600 may be used to drill a hole in a solid block of material 2000.

When the hole is a suitable depth, the assembly of the power tool 1500, the power tool adapter 100, and the drill bit 1600 is withdrawn from the hole and the torque sleeve 1700 is fitted over the drill bit 1600. The torque sleeve 1700 locks on the sleeve gripper 800. In FIG. 9, the drill bit 1600 and torque sleeve 1700 are simultaneously secured to the power tool adapter 100.

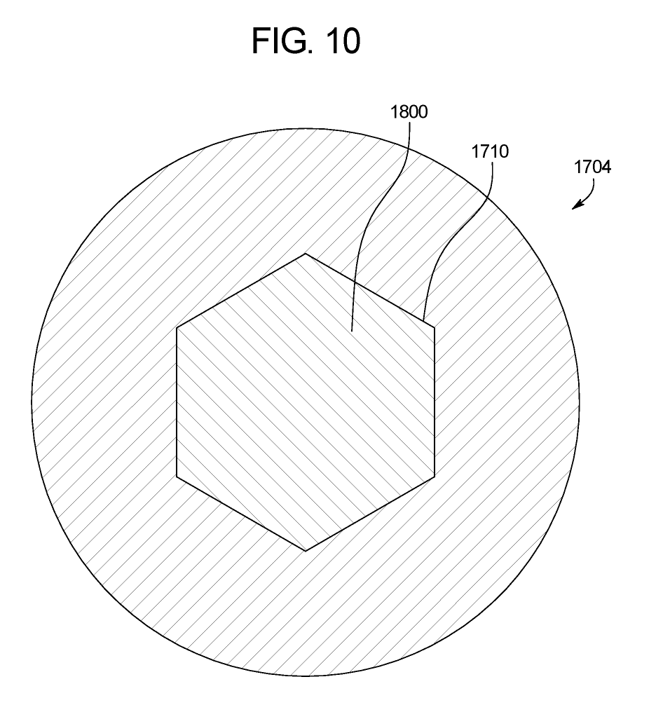

As shown in or indicated by FIGS. 7 and 10, an impact screw bit 1800 is locked into the hexagonal slot defined in the impact bit engager 1704 of the torque sleeve 1700. The impact screw bit 1800 engages a head of a screw 1900. The impact screw bit drives or threads the screw 1900 into the hole defined in the block of material 2000. When the screw 1900 is threaded into place, the torque sleeve 1700 can be pulled off the power tool adapter 100 to expose the drill bit 1600 for drilling a new hole.

It should thus be appreciated that when using the power tool adapter of various embodiments of the present disclosure with an impact driver, a user no longer needs to: (a) eject an impact drill bit; (b) store the impact drill bit; (c) search for an impact screw bit; (d) mount the impact screw bit; (e) eject the impact screw bit; (f) store the impact screw bit; (g) find the impact drill bit; and (h) mount the impact drill bit.

It should thus be appreciated that when using the power tool adapter of various embodiments of the present disclosure with a standard drill, a user no longer needs to: (a) eject a drill bit; (b) store the drill bit; (c) search for a screw bit; (d) mount the screw bit; (e) eject the screw bit; (f) store the screw bit; (g) find the drill bit; and (h) mount the drill bit.

It should be appreciated that in various embodiments of the present disclosure, the head 300 and the extender 500 have identical cross sections. In various embodiments of the present disclosure, the first sleeve engager 1000 and the second sleeve engager 1200 also have identical cross sections. In various embodiments of the present disclosure, the hexagonal perimeter of the sleeve gripper 800 is larger than the hexagonal perimeter of the shank 300.

The present embodiment shows the head 300, the extender 500, and the sleeve engagers 1000 and 1200 having a hexagonal cross section. It should be appreciated that in various other example embodiments, the head 300, the extender 500, and the sleeve engagers 1000 and 1200 may have any other suitable cross section, such as a square, a rectangle, a trapezoid, a pentagon, an octagon, or an ellipse.

In the present embodiment, the neck or clip retainer 400, the drill bit locker 600, and the cylindrical extenders 900 and 1100 have a circular cross section. It should be appreciated that in other example embodiments of the present disclosure the neck or clip retainer 400, the drill bit locker 600, and the cylindrical extenders 900 and 1100 may be of any other suitable cross section such as a square, a rectangle, a trapezoid, a pentagon, an octagon, or an ellipse.

In the present example illustrated embodiment, the oval-shaped exterior surfaces of the head 300, the extender 500, the first sleeve engager 1000, and the second sleeve engager 1200 are flat surfaces defined by two straight edges and two curved edges. In other example embodiments of the present disclosure, the exterior surfaces of the head 300, the extender 500, the first sleeve engager 1000, and the second sleeve engager 1200 are flat surfaces with any suitable shape, such as a rectangle.

In the present example illustrated embodiment of the present disclosure, the hexagonal inner surfaces 1710 and 1716 of the torque sleeve 1700 are different and specifically the first hexagonal inner surface 1708 has a smaller diameter than the second hexagonal inner surface 1716. It should be appreciated that in other example embodiments, this configuration may vary.

In the present illustrated example embodiment, the torque sleeve 1700 includes two retainers. It should be appreciated that other example embodiments have any suitable number of retainers. In one embodiment, the torque sleeve 1700 has four retainers: two for engaging the power tool adapter and two for engaging an impact bit.

In the present illustrated example embodiment, the first retainer 1710a has a greater diameter than the second retainer 1710b. More specifically, the ball or clip 1732a of the first retainer 1710a has a greater diameter than the ball or clip 1732 of the second retainer 1710b. The inner surface 1730a of the first retainer 1710a has a greater diameter than the inner surface 1730b of the second retainer 1710b. In other example embodiments, the diameters of the first and second retainers 1710a and 1710b are the same. It should also be appreciated that the size of the balls 1732a and 1732b may vary in accordance with the present disclosure. It should further be appreciated that the thicknesses of the bands 1734a and 1734b may vary in accordance with the present disclosure.

In the present illustrated example embodiment, the diameters of the generally cylindrical inner surfaces 1740 and 1742 are the same. In other example embodiments, the diameters are different. It should be appreciated that in the present illustrated example embodiment, the diameter of the generally cylindrical inner surface 1740 is smaller than the diameter of the first hexagonal inner surface 1708. It should also be appreciated that in the present illustrated example embodiment, the diameter of the generally cylindrical inner surface 1742 is smaller than the diameter of the second hexagonal inner surface 1716. It should be appreciated that in other example embodiments, this configuration may vary.

In this illustrated example embodiment, the first cylindrical extender 900 partially defines a first recess or slot 902 (indicated by a phantom line in FIG. 2). In various embodiments, a third retainer of a modified torque sleeve 1700 is configured to engage the slot 902. More specifically in these embodiments, the first recess or slot 902 (indicated by a phantom line in FIG. 2) is defined between the outer surface or perimeter 904 of the first extender body, the inner hexagonal surface 1708 of the modified torque sleeve 1700, the drill bit locker 600, and the first collar engager 1000. When the third retaining ball or clip of the modified torque sleeve 1700 lines up with the first recess or slot 902, a spring or band in the modified torque sleeve 1700 pushes the retaining clip or ball partially into the first recess or slot 902. The spring or band biases or holds the retaining ball or clip in the first recess or slot 902, and prevents the torque sleeve from unwanted longitudinal movement along the power tool adapter.

In this illustrated example embodiment, the torque sleeve 1700 is configured to fit over the sleeve gripper 800, but not the drill bit locker 600. In this illustrated example embodiment, the outer diameter of the torque sleeve 1700 is substantially equal to the outer diameter of the drill bit locker 600. In various embodiments, the torque sleeve 1700 is configured to fit around both of the sleeve gripper 800 and the drill bit locker 600. In these embodiments, the torque sleeve 1700 includes a hollow cylindrical section lateral to the adapter engager 1702. The hollow cylindrical section has an inner diameter configured to be positioned around or journal the drill bit locker 600.

In various embodiments, the power tool adapter of the present disclosure is formed from a single stock of metal. More specifically, in one example embodiment, a manufacturer cuts the stock of metal into a first cylinder having a diameter equal to the diameter of the drill bit locker 600 and a length equal to the complete longitudinal length of the power tool adapter 100.

The manufacturer reduces a first end of the first cylinder corresponding to the shank or drill coupler 200 (excluding the transition 508) into a second cylinder. The second cylinder is cut to have a hexagonal perimeter. The manufacturer forms the clip retainer 400 by removing a strip of material corresponding to the gap 406 from a perimeter of the hexagonal cylinder. The manufacturer chamfers edges between the exterior surfaces 304 and the flat bottom 302.

The manufacturer reduces a second end of the first cylinder corresponding to the sleeve gripper 800 to a third cylinder. The third cylinder is then cut to have a hexagonal perimeter corresponding to the sleeve engagers 1000 and 1200. The manufacturer generates the extenders 900 and 1100 by removing strips of material from the hexagonal perimeter. The manufacturer forms the lip 1300 by cutting into the second engager 1200 in a plane defined by edges 1204a and 1204d. The manufacturer then rounds the bottom of the lip.

The manufacturer bores a smooth hole corresponding to the drill bit receiving slot 1400 through the sleeve gripper 800 and partially through the drill bit locker 600. The manufacturer bores a threaded hole corresponding to the set screw opening 608 through the drill bit locker 600 until the threaded hole intersects the drill bit receiving slot 1400.

It should be appreciated from the above that in various embodiments, the present disclosure includes the power tool adapter, the torque sleeve, and a combination of the power tool adapter and the torque sleeve.

It should be understood that modifications and variations may be effected without departing from the scope of the novel concepts of the present disclosure, and it should be understood that this application is to be limited only by the scope of the appended claims.

The invention is claimed as follows:

1. A power tool adapter comprising:
a drill coupler including a head, a clip retainer, and an extender, the drill coupler configured to be received in both an impact driver and a standard drill;
a drill bit locker defining a first portion of a drill bit receiving slot; and
a sleeve gripper defining a second portion of the drill bit receiving slot and including one or more sleeve engagers, the sleeve gripper configured to simultaneously hold a drill bit and engage inner surfaces of a torque sleeve positioned around the sleeve gripper.

2. The power tool adapter of claim 1, wherein the head and the extender have identical hexagonal cross sections.

3. The power tool adapter of claim 1, wherein the drill bit locker defines a set screw opening intersecting the first portion of the drill bit receiving slot and extending through an outer surface of the drill bit locker.

4. The power tool adapter of claim 3, wherein the set screw opening is threaded.

5. The power tool adapter of claim 1, wherein the sleeve gripper includes at least two sleeve engagers.

6. The power tool adapter of claim 5, wherein the sleeve engagers have identical hexagonal cross sections.

7. The power tool adapter of claim 5, wherein the sleeve gripper includes a lip protruding from an outer one of the sleeve engagers.

8. The power tool adapter of claim 1, wherein the shank, the drill bit locker, and the sleeve gripper are integrally formed.

9. A power tool adapter comprising:
a drill coupler configured to be received in both an impact driver and a standard drill, the drill coupler including:
a head having a first cross section, the head including a flat bottom and a plurality of first identical exterior surfaces,
an hourglass shaped clip retainer configured to receive a retaining ball or clip, and
an extender having a second cross section and a plurality of second identical exterior surfaces;
a drill bit locker having a third cross section, the drill bit locker integrally connected to the drill coupler and defining:
a first portion of a cylindrical drill bit receiving slot, and
a set screw opening transversely extending from the drill bit receiving slot;
a sleeve gripper configured to simultaneously hold a drill bit and engage inner surfaces of a torque sleeve positioned around the sleeve gripper, the sleeve gripper integrally connected to the drill bit locker and defining a second portion of the drill bit receiving slot, the sleeve gripper including:
an extender having a fourth cross section, the extender configured to partially define a slot configured to receive a retaining ball or clip, and
a sleeve engager with a plurality of third exterior surfaces and a fifth cross section;
wherein each cross section has a diameter, the diameters of the first cross section and the second cross section are equal, the diameter of the fifth cross section is greater than the diameters of the first and second cross sections, and the diameter of the third cross section is greater than the diameters of the first, second, fourth, and fifth cross sections.

10. The power tool adapter of claim 9, wherein the head and the extender have identical hexagonal cross sections.

11. The power tool adapter of claim 9, wherein the first and second exterior surfaces are oval-shaped with two opposing curved edges and two opposing straight edges.

12. The power tool adapter of claim 9, wherein the set screw opening is threaded.

13. The power tool adapter of claim 9, wherein the sleeve gripper includes at least two sleeve engagers.

14. The power tool adapter of claim 13, wherein the sleeve engagers have identical hexagonal cross sections.

15. The power tool adapter of claim 14, wherein one of the two sleeve engagers is longer another of the at least two sleeve engagers.

16. The power tool adapter of claim 9, wherein the sleeve gripper includes a lip protruding from one of the sleeve engagers, the lip including:
a semi-conical lip body with a semi-cylindrical inner surface,
triangular inner surfaces meeting the semi-cylindrical inner surface along a plurality of edges,
a semi-conical outer surface, and
an edge joining the outer surface to the semi-cylindrical inner surface.

17. A tool assembly comprising:
a torque sleeve with an inner surface, the power tool adapter of claim 9, and a drill bit;
wherein the one or more sleeve engagers of the sleeve gripper are secured in the inner surface of the torque sleeve and the drill bit is secured in the first and second portions of the drill bit receiving slot.

18. The tool assembly of claim 17, wherein the torque sleeve includes a retainer, and the retainer includes a circumferential band, an inner surface defining a channel, and a retaining ball.

19. The tool assembly of claim 18, wherein the retaining ball of the torque sleeve is configured to be received in the slot partially defined by the sleeve gripper of the power tool adapter.

20. The tool assembly of claim 19, wherein the channel is tapered.
